(19) United States
(12) Patent Application Publication
(10) Pub. No.: US 2004/0079207 A1
(43) Pub. Date: Apr. 29, 2004

(54) Machine tool apparatus

(75) Inventors: Hideyumi Matsumura, Inuyama (JP); Hiroshi Yoshimura, Inuyama (JP); Yukihiro Murakami, Inuyama (JP)

Correspondence Address: BROWDY AND NEIMARK, P.L.L.C., 624 NINTH STREET, NW, SUITE 300, WASHINGTON, DC, 20001-5303, US

(73) Assignee: DAIDO METAL COMPNAY LTD., Naka-ku (JP)

(21) Appl. No.: 10/688,980

(22) Filed: Oct. 21, 2003

(30) Foreign Application Priority Data
Oct. 21, 2002 (JP) 2002-305214

(51) Int. Cl. B23B 25/00; B23Q 11/10

(52) U.S. Cl. 82/158; 82/900; 408/58; 408/60; 409/136

(57) ABSTRACT

There is provided a machine tool apparatus provided with coolant supply passages for supplying a coolant in tools or tool mounts for mounting the tools. An oil coated water droplet generator/mixer is connected to the beginning end of the coolant supply passages, and a spray port having a smaller inner diameter than that of the coolant supply passages is connected to the termination end of the coolant supply passages such that the oil coated water droplets generated in an atomized state by the oil coated droplet generator/mixer flow in a liquid state through a coolant supply passages while having a droplet shape on a surface of which in the greater part of oil coated water droplets an oil film is formed and are sprayed again in an atmized state from the spray port. As a result, excessive dispersion of the coolant in the air is restrained in comparison with the case where only oil is sprayed, and satisfactory lubricating and cooling effects are ensured with the minimal quantity of the coolant since the oil coated water droplets adhere to the work surface, and at the same time, excellent workshop environment is provided.

### BACKGROUND OF THE INVENTION

1. Field of the Invention

The present invention relates to a machine tool apparatus provided with coolant supply passages for supplying a coolant in tools or tool mounts for mounting the tools.

2. Description of the Related Art

Conventionally, in performing a machining operation such as cutting, grinding or the like a coolant such as oil, emulsion or the like has been poured in a liquid state or sprayed after atomizing the coolant onto the work surface of a workpiece from a nozzle facing to the vicinity of the work point to lubricate a contact point between the workpiece and the tool and also to remove the heat generated by the machining to thereby advance the machining precision and extend the tool life. In this case, to enhance lubricating and cooling effects it has been proposed to arrange coolant supply passages and spray ports in tool mounts to mount tools (see the following Patent Document 1) or similarly to arrange coolant supply passages and spray ports in tools themselves (see the following Patent Document 2).

PATENT DOCUMENT 1

JP-A-8-141877 (FIG. 1, the paragraph corresponding thereto)

PATENT DOCUMENT 2

JP-A-9-183002 (FIG. 1, the paragraph corresponding thereto)

Even if providing of coolant supply passages or spray ports in tools or tool mounts may be suitable to increase lubricating and cooling effects, however, using of a conventional coolant such as water, oil, emulsion, or air has still a disadvantage to consume a large amount of the coolant. Particularly, an incombustible emulsion has a problem to incur a high cost in treating a large amount of used or old emulsion as deteriorated emulsion is hard to treat as an industrial refuse. On the other hand, in case of spraying an atomized coolant with an aim to reduce consumption of the coolant, the oil if sprayed disperses excessively into the air due to its small mass. As a result, no sufficient amount of oil adheres to the work surface of a workpiece creating a problem that no satisfactory lubrication between the workpiece and the tool and also cooling of the work point can be ensured. In addition, the excessive dispersion of the atomized oil may present a problem in workshop environment including a threat of fire and an adverse impact on workers. Furthermore, the method of spraying a mixture of water and oil also raises a similar problem resulting from excessive dispersion of the oil portion into the air.

### SUMMARY OF THE INVENTION

The present invention has been made in view of the foregoing circumstances, and its object is to provide a machine tool apparatus including coolant supply passages for supplying a coolant in tools or tool mounts for mounting the tools, wherein consumption of the coolant can be reduced and the environmental burden is intended to be reduced to the minimal.

To achieve the object as stated above, according to the invention as defined in claim 1 there is provided a machine tool apparatus provided with coolant supply passages for supplying a coolant in tools or tool mounts for mounting the tools, the apparatus comprising an oil coated water droplet generator/mixer to the beginning end of the coolant supply passages, the oil coated water droplet generator/mixer including an oil atomizing chamber for atomizing oil introduced from the outside by an air stream, water droplet generation chambers for generating oil coated water droplets having oil films on the surfaces of the water droplets generated by dropping water introduced from the outside utilizing the air stream containing the atomized oil generated in the oil atomizing chamber, and a top nozzle to discharge the oil coated water droplets generated in the water droplet generation chambers is connected, wherein a spray port having a smaller inner diameter than the inner diameter of the coolant supply passages is connected to the termination end of the coolant supply passages. According to this configuration, the oil coated water droplets generated in an atomized state by the oil coated water droplet generator/mixer flow in a liquid state through a coolant supply passages while having a droplet shape in the greater part of oil coated water droplets on a surface of which an oil film is formed, and the oil coated water droplets are sprayed again in an atomized state from the spray ports. As a result, excessive dispersion of the coolant in the air is restrained in comparison with the case where only oil is sprayed and satisfactory lubricating and cooling effects are ensured with the minimal quantity of the coolant as the oil coated water droplets adhere to the work surface, and at the same time, excellent workshop environment is provided.

### BRIEF DESCRIPTION OF THE DRAWING

FIG. 1 is an exploded perspective view of tool mounts of a turret lathe.

FIG. 2 is a front view of the tool mounts of the turret lathe.

FIG. 3 is a side elevational view of a fore end portion of the tool wherein coolant supply passages are formed.

FIG. 4 is a sectional view showing the interior of an oil coated water droplet generator/mixer in accordance with an embodiment of the present invention.

FIG. 5 is a schematic view of an oil coated water droplet supply system for supplying air, oil, and water into the oil coated water droplet generator/mixer.

FIG. 6 is a graph showing a distribution of density based on particle sizes in comparison of the case of spraying atomized oil according to the embodiment of the present invention with the conventional case.

FIG. 7 is a graph showing amounts of air consumed in comparison of the case of spraying atomized oil and blowing dry air according to the embodiment of the present invention with the conventional case.

FIG. 8 is a graph showing a relationship between the number of workpieces machined and roughness of the surfaces in comparison of the case of the air blowing according to the embodiment of the present invention with the conventional case.

### DESCRIPTION OF THE PREFERRED EMBODIMENT

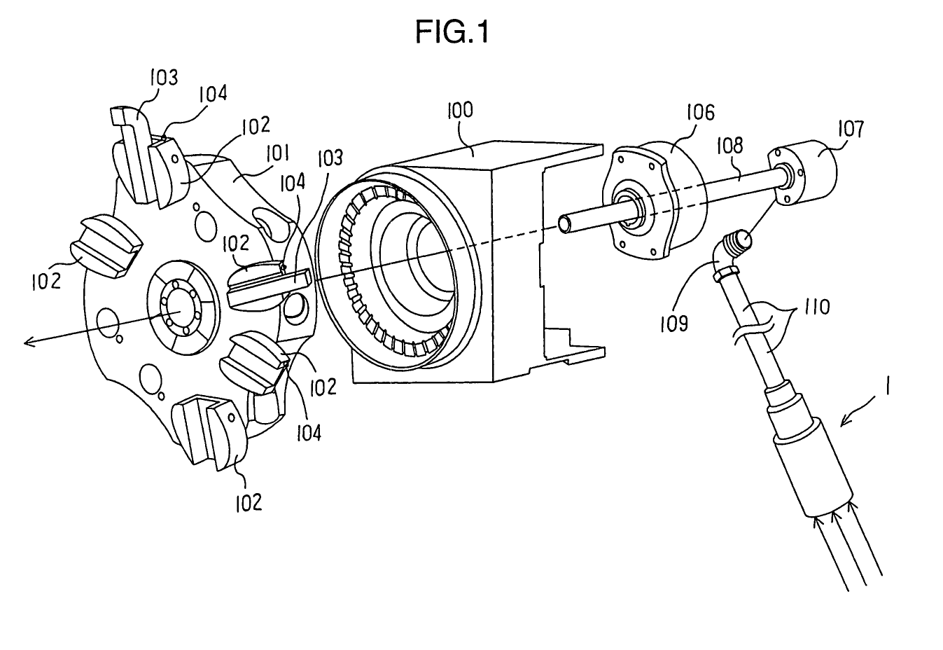

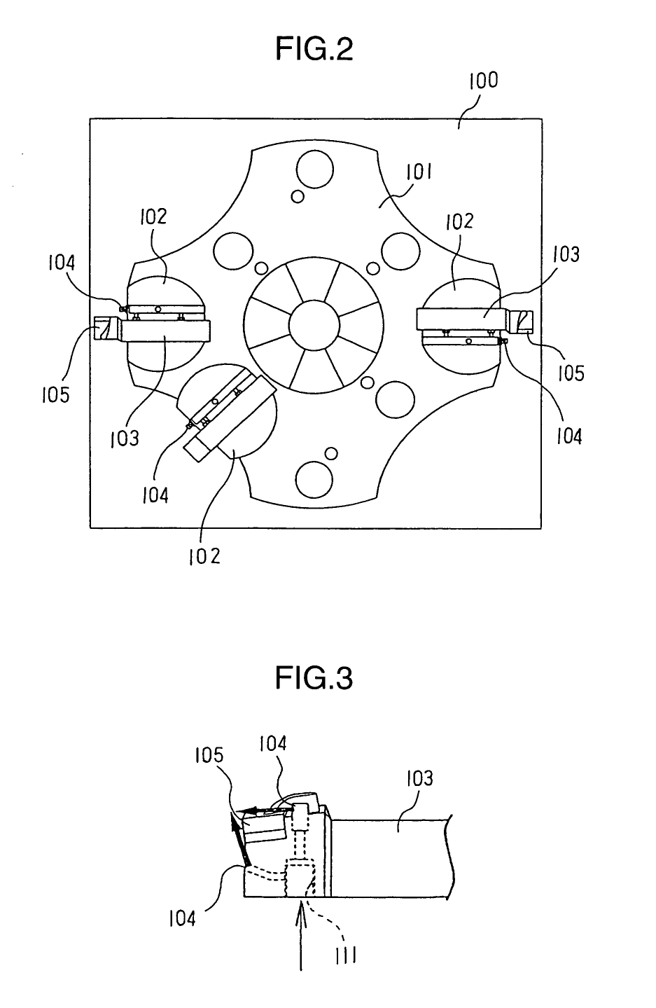

Referring to the drawings, an embodiment of the present invention will be described hereinafter. With reference specifically to FIGS. 1 and 2, tool mounts of a turret lathe as an example of a machine tool will be described. FIG. 1 is an exploded perspective view of the tool mounts of the turret lathe and FIG. 2 is a front view of the tool mounts of the turret lathe.

In these figures, a turret body 101 is provided on the front of a turret support 100 to rotate positively by a predetermined angle. On the front of the turret body 101, tool holders 102 capable of receiving various tools 103 are secured removably thereto. Each of the tool holders 102 is provided with a spray port 104 to spray a coolant toward a work tip 105 of the tool 103. In addition, supply passages (not shown) for conducting the coolant supplied through a supply pipe 108 as will be described later are formed in the turret body 101 and the tool holders 102.

On the back of the turret support 100, a bearing member 106 for journaling the rear end of a shaft (not shown) of the turret body 101 is mounted, and also on the back of the bearing member 106 a connector 107 is fixed. On the connector 107 a supply pipe 108 is fixed extending forwardly and on the side of the connector 107 a coupling 109 for connecting with an oil coated water droplet generator/mixer 1 as described later by way of a flexible pipe 110 is mounted. The forward end (front end) of the supply pipe 108 is inserted into the inside of the turret body 101 and configured such that the connection with the supply passages formed as described above in the turret body 101 and the tool holders 102 is ensured without any leakage of the coolant. In this regard, it is constructed such that only a supply passage corresponding to one of the tools 103 mounted on the turret body 101 and designated for use by occupying a predetermined position after rotation of the turret body 101 can establish fluid communication with the supply pipe 108.

In case of the tool mount of the turret lathe with such configuration as described above, a coolant once sprayed from the oil coated water droplet generator/mixer 1 into the flexible pipe 110 flows through the supply pipe 108 and the supply passages provided in the turret body 101 and the tool holders 102 is re-sprayed from one of the spray ports 104 toward the work tip of the tool 103 in use. Consequently, the supply passages formed in the flexible pipe 110, the supply pipe 108, and the turret body 101 and the tool holders 102 constitute coolant supply passages for supplying a coolant, and the beginning end of the coolant supply passages is connected to the oil coated water droplet generator/mixer 1, and the termination end is connected to the spray ports 104. Furthermore, the supply passages formed in the flexible pipe 110, the supply pipe 108, and the turret body 101 and the tool holders 102 for constituting the coolant supply passages are constructed so as to have substantially a same inner diameter, and the inner diameter of the spray ports 104 is formed to be smaller than that of the coolant supply passages.

Then, the coolant sprayed from the oil coated water droplet generator/mixer 1 is atomized water coated with oil films. The whole of the oil coated water droplets sprayed into the coolant supply passages does not necessarily travel forwardly along the coolant supply passages in an atomized state, but a certain portion reaches one of the spray ports 104 flowing along the inner wall of the coolant supply passages in a liquid state. Then, as the inner diameter of the spray ports 104 is smaller than that of the coolant supply passages, the portion flown in a liquid state is atomized again when discharged from one of the spray ports 104 toward the work point. Furthermore, it is conceived that even though a certain portion of the oil coated water droplets travels along the coolant supply passages in a liquid state as mentioned above the portion may not be separated completely into oil and water, and the greater part of oil coated water droplets reaches the spray port 104 while maintaining a configuration thereof when sprayed into the coolant supply passages by the oil coated water droplet generator/mixer (the configuration of an oil film being formed on the surfaces of the water droplets). And, the oil coated water droplets reaching the spray port 104 are sprayed from the spray port 104 in a manner of an oil film being formed on the surfaces of the water droplets. As a result, in comparison with a prior art where only atomized oil is sprayed, the present invention constrains excessive adhesion of oil into the air and permits appropriate adhesion of the oil coated water droplets onto the work surface of the workpiece, thereby an extremely small supply quantity of coolant ensures satisfactory lubricating and cooling effects and maintenance of an excellent workshop environment.

Although in the embodiment as shown in FIGS. 1 and 2 the case where the supply passages are formed in the turret body 101 and the tool holders 102 has been illustrated, the supply conduits 111 may be constructed within a tool 103 itself mounted on a tool holder 102 as shown in FIG. 3. Although the supply conduits 111 as shown in FIG. 3 are constructed such that a coolant can be discharged toward both the front and the back of the work tip 105 from the spray port 104 after bifurcation directly receiving the coupling 109 as shown in FIG. 1, supply passages communicating with the supply passages in the turret body 101 and the tool holder 102 may be formed in the tool 103.

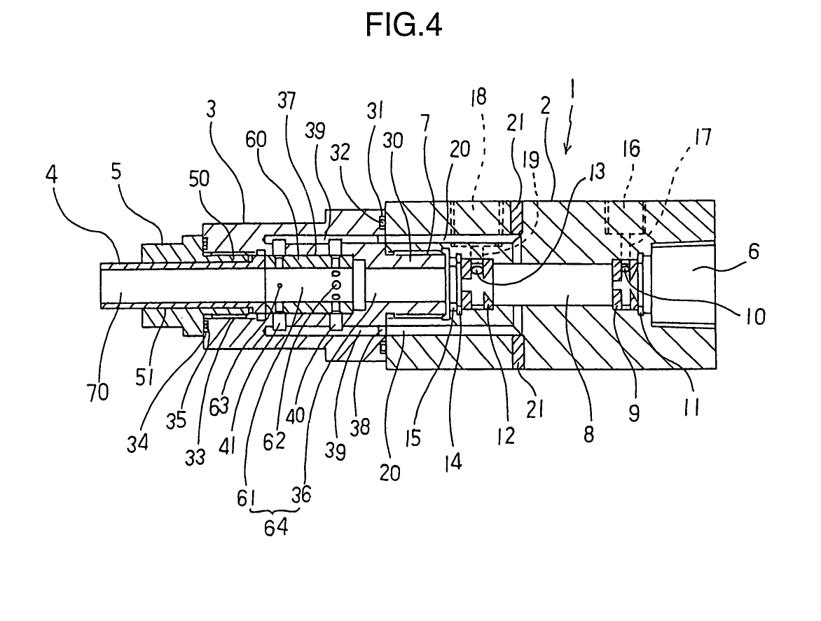

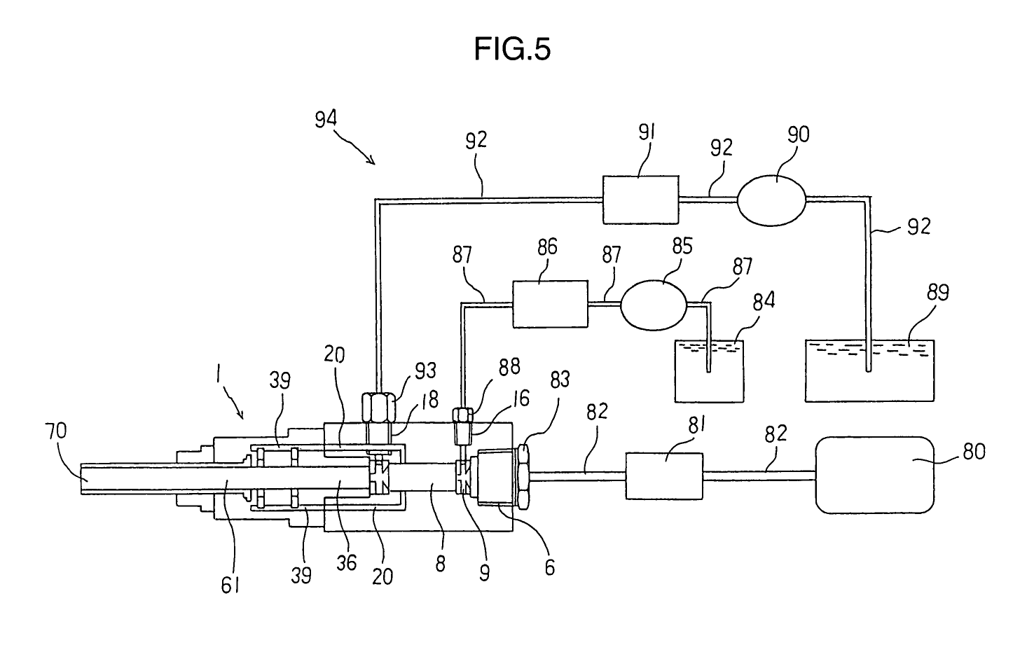

The oil coated water droplet generator/mixer 1 connected to the coolant supply passages as described above has a structure as shown in FIGS. 4 and 5. Referring to FIGS. 4 and 5 the structure of the oil coated water droplet generator/mixer 1 will be described. FIG. 4 is a sectional view showing the interior of the oil coated water droplet generator/mixer 1 of the embodiment. FIG. 5 is an outline drawing of an oil coated water droplet supply system 94 to feed air, oil, and water to the oil coated water droplet generator/mixer 1.

As shown in FIG. 4 the oil coated water droplet generator/mixer 1 comprises a fog chamber structural member 2 constructing an oil atomizing chamber 8 to atomize oil introduced from the outside by an air stream, a secondary fog chamber structural member 3 connected to the fog chamber structural member 2 and constructing water droplet generation chambers 36, 61 to generate oil coated water droplets by dropping water introduced from the outside by the air stream containing the atomized oil atomized in the oil atomizing chamber 8, a top nozzle 4 connected to the secondary fog chamber structural member 3 and for discharging the oil coated water droplets generated as described above, and a nozzle case 5 to fix the top nozzle 4 to the secondary fog chamber structural member 3.

First, referring to FIG. 4 the structure of the fog chamber structural member 2 will be described. The fog chamber structural member 2 is a square pillar or a cylindrical shape member formed from a stainless steel or plastics. In the center of the rear end face (right side in the drawing) of the fog chamber structural member 2 a recessed air inlet 6 for connection with an air supply duct 82 to supply compressed air (refer to FIG. 5) is formed. On the other hand, in the center of the fore end face (left side in the drawing) of the fog chamber structural member 2 a mounting recess 7 for fitting over the secondary fog chamber structural member 3 is provided. From the bottom of the air inlet 6 to the bottom of the mounting recess 7 an oil atomizing chamber 8 is formed passing through the fog chamber structural member 2. In addition, the inner circumferential surface of the air inlet 6 is threaded to accept the air duct 82, and also the inner circumferential surface of the mounting recess 7 is threaded to threadably accommodate the secondary fog chamber structural member 3.

In the both end portions of the oil atomizing chamber 8 spray nozzles 9, 12 are fit securely. More precisely, on the side of the air inlet 6 an oil spray nozzle 9 to atomize oil introduced from the outside is fit and secured by a gap ring 11. On the side of the mounting recess 7 a water spray nozzle 12 to drop water introduced from the outside is fit and secured by a gap ring 14. The oil spray nozzle 9 is provided with a first oil inlet 10 to permit oil to flow into the oil spray nozzle 9. Similarly, the water spray nozzle 12 is provided with a water inlet 13 to permit water to flow into the water spray nozzle 12.

Then, in a side wall of the fog chamber structural member 2 and adjacent to the air inlet port 6, an oil inlet port 16 is provided for connection with an oil supply duct 87 to feed oil (refer to FIG. 5), and from the bottom of the oil inlet port 16 toward the first oil inlet port 10 an oil inlet passage 17 is formed. Also in the side wall radially same side with the oil inlet port 16 and adjacent to the mounting recess 7, a water inlet port 18 is provided to connect with a water supply duct 92 (refer to FIG. 5) to feed water, and from the bottom of the water inlet port 18 toward the water inlet 13 a water inlet passage 19 is formed.

Furthermore, from the end face of the fog chamber structural member 2 adjacent to the mounting recess 7 two L-shaped first bypass passages 20 communicating with the oil atomizing chamber 8 are provided at radially opposed positions. In the zones extending from the bends in the first bypass passages 20 to the radially outer sides of the fog chamber structural member 2 block members 21 are inserted. Each of the block members 21 is required to block substantially a half of the respective through hole formed from the side of the fog chamber structural member 2 to the oil atomizing chamber 8 and configure each of the first bypass passages 20 into an L-shape. In other words, since it is impossible to make an L-shaped passage, a first passage is formed from the end surface of the fog chamber structural member 2 and then a second passage normal to the first passage is formed from the side of the fog chamber structural member 2 through the oil atomizing chamber 8 passing through the dead end of the first passage to form a T-shaped passage, and then the section of the old passage extending from the cross section to the side of the fog chamber structural member 2 is blocked by the block member 21 to form the L-shaped passage as described above.

Now, the structure of the secondary fog chamber structural member 3 will be described. The secondary fog chamber structural member 3 is a cylindrical member formed from a stainless steel or plastics. Then, in the center of the rear end surface of the secondary fog chamber structural member 3 (right side in the drawing) a mounting protrusion 30 for insertion into the mounting recess 7 of the fog chamber structural member 2 is formed. In the rear end surface adjacent to the outer periphery an O-ring mounting groove 31 to fit an O-ring 32 is arranged annularly and between the O-ring mounting groove 31 and the mounting protrusion 30 a bypass passage connecting groove 38 connected to the first bypass passages 20 is formed circularly. The bypass passage connecting groove 38 is arranged such that the diameter of a circle drawn in the center of the bypass passage connecting groove 38 is substantially the same with the distance between the two center lines of the first bypass passages 20 and its width is substantially the same with the inner diameter of the first bypass passages 20. In addition, the outer circumferential surface of the mounting protrusion 30 is threaded for engagement with the threads provided in the inner circumferential surface of the mounting recess 7.

On the other hand, in the center of the fore end face of the secondary fog chamber structural member 3 (left side in the drawing) a nozzle case insert recess 33 provided with threads on its inner circumferential surface for mounting the nozzle case 5 is formed. In the fore end face adjacent to the outer periphery an O-ring mounting groove 34 to fit an O-ring 35 is formed circularly. Also, from the bottom of the mounting recess 7 toward the end face of the mounting protrusion 30 a water droplet generation chamber 64 is formed therethrough to generate water droplets from water introduced from the outside. The water droplet generation chamber 64 comprises a first water droplet generation chamber 36 on the upstream side and a second water droplet generation chamber 61 on the downstream side. The second water droplet generation chamber 61 on the downstream side is configured by a secondary oil nozzle 60 fitted in a secondary oil nozzle mount 37 formed adjacent to the nozzle case insert recess 33.

From the bottom of the bypass passage connecting groove 38 extending in a direction toward the fore end face of the secondary fog chamber structural member 3 up to the position of the secondary oil nozzle mount 37, second bypass passages 39 are formed. The second bypass passages 39 are arranged at two radially opposed positions. In addition, at two locations of the second bypass passage 39, right and left in the drawing, first oil inlet passages 40 and second oil inlet passages 41 are formed to permit communication between the second bypass passages 39 and the secondary oil nozzle mount 37.

By the way, in the secondary oil nozzle mount 37 the secondary oil nozzle 60 is fitted as mentioned above. The secondary oil nozzle 60 is made from a stainless steel or a copper base alloy into a cylindrical shape and is provided at its center with a second water droplet generation chamber 61 having a same diameter with that of the first water droplet generation chamber 36. Also at locations adjacent to the rear end surface of the secondary oil nozzle 60 (right side in the drawing) second oil inlets 62 formed to serve as upstream oil inlets are provided passing from the outer surface of the secondary oil nozzle 60 through to the second water droplet generation chamber 61. The second oil inlets 62 are provided radially at a plurality of equi-spaced locations (4-12 locations). Also at locations adjacent to the fore end face of the secondary oil nozzle 60 (left side in the drawing) third oil inlets 63 formed to serve as downstream oil inlets similarly with the second oil inlets 62 are provided passing from the outer surface of the secondary oil nozzle 60 through to the second water droplet generation chamber 61. The third oil inlets 63 are provided radially at a plurality of equi-spaced locations (approximately one half of that of the second oil inlets 62, namely 2-6 locations). In this embodiment, the diameter of the second oil inlets 62 are set to be double or more of that of the third oil inlets 63.

When the secondary oil nozzle 60 constructed as above is inserted into the secondary oil nozzle mount 37 each of the second oil inlets 62 meets corresponding one of the first oil inlet grooves 40 and also each of the third oil inlets 63 meets corresponding one of the second oil inlet grooves 41.

Now, the structure of the top nozzle 4 will be described. The top nozzle 4 is formed from a stainless steel or plastics into a cylindrical shape and is provided at its center with an oil coated water droplet discharge port 70 to discharge water droplets coated with oil films having an inner diameter substantially the same with that of the second water droplet generation chamber 61. On the rear end face of the top nozzle 4 (right side in the drawing) a flange is formed and the diameter of the flange is substantially the same with the external diameter of the secondary oil nozzle 60.

The top nozzle 4 is fixed to the secondary fog chamber structural member 3 by means of the nozzle case 5 which is formed from a stainless steel or a copper base alloy into a cylindrical shape. In addition, in the center of the rear end face of the nozzle case 5 (right side in the drawing) a mounting protrusion 50 is formed. The mounting protrusion 50 is provided on its outer circumferential surface a thread portion for threading into the nozzle case insert recess 33 of the secondary fog chamber structural member 3. Also in the center of the nozzle case 5 a top nozzle insert hole 51 for insertion of the top nozzle 4 is formed.

Assembling of the oil coated water droplet generator/mixer 1 constructed with a plurality of members as mentioned above will be described hereinafter. First, after mounting the O-ring 32 in the O-ring mounting groove 31 provided in the rear end face of the secondary fog chamber structural member 3, the mounting protrusion 30 of the secondary fog chamber structural member 3 is threaded in the mounting recess 7 of the fog chamber structural member 2 to attach the secondary fog chamber structural member 3 to the fog chamber structural member 2. In this case, as the depth of the O-ring mounting groove 31 is smaller than the diameter of the O-ring 32, when the O-ring 32 is mounted in the O-ring mounting groove 31, the upper part of the O-ring 32 protrudes from the rear end face of the secondary fog chamber structural member 3. Consequently, when the secondary fog chamber structural member 3 is secured to the fog chamber structural member 2 the O-ring 32 is pinched between the bottom of the O-ring mounting groove 31 and the fore end surface of the fog chamber structural member 2 to secure an air tight condition between the fog chamber structural member 2 and the secondary fog chamber structural member 3. In addition, as the O-ring 15 is interposed between the gap ring 14 and the end face of the mounting protrusion 30, communication between the oil atomizing chamber 8 and the first water droplet generation chamber 36 is established maintaining an air tight condition.

Also as the bypass passage connecting groove 38 in the rear end face of the secondary fog chamber structural member 3 is arranged annularly, when the secondary fog chamber structural member 3 is attached to the fog chamber structural member 2, the first bypass passages 20 establish communication with the bypass passage connecting groove 38. Consequently, the first bypass passages 20 communicate with the second bypass passages 39 by way of the bypass passage connecting groove 38.

Then, the secondary oil nozzle 60 is inserted from the side of the nozzle case insert recess 33 into the secondary oil nozzle mount 37 of the secondary fog chamber structural member 3. In this case, the side of the second oil inlet 62 is inserted first. When the secondary oil nozzle 60 is inserted into the secondary oil nozzle mount 37, as mentioned above, each of the second oil inlets 62 is located at a position corresponding to one of the first oil inlet grooves 40 and each of the third oil inlets 63 is located at a position corresponding to one of the second bypass passages 41. Consequently, the second bypass passages 39 establish communication with the second water droplet generation chamber 61 by way of the first oil inlet grooves 40 and the second oil inlets 62 as well as the second oil inlet grooves 41 and the third oil inlets 63.

Then, after mounting the O-ring 35 in the O-ring mounting groove 34 formed in the fore end face of the secondary fog chamber structural member 3, the top nozzle 4 is inserted from the flange side into the nozzle case insert recess 33 of the secondary fog chamber structural member 3. Then, after mounting the nozzle case 5 over the top nozzle 4, the mounting protrusion 50 of the nozzle case 5 is threaded into the nozzle case insert recess 33 of the secondary fog chamber structural member 3 for securing both of the top nozzle 4 and the nozzle case 5 to the secondary fog chamber structural member 3. In this respect, as the O-ring mounting groove 34 has a depth smaller than the diameter of the O-ring 35, when the O-ring 35 is mounted on the O-ring mounting groove 34, the upper part of the O-ring 35 protrudes from the fore end face of the secondary fog chamber structural member 3. Consequently, when the nozzle case 5 is secured to the secondary fog chamber structural member 3, the O-ring 35 is pinched between the bottom of the O-ring mounting groove 34 and the rear end face of the nozzle case 5 to secure an air tight condition between the secondary fog chamber structural member 3 and the nozzle case 5.

The assembling of the oil coated water droplet generator/mixer 1 has been described. Now referring to FIG. 5, the oil coated water droplet supply system 94 to feed air, oil, and water to the oil coated water droplet generator/mixer 1 will be described.

In FIG. 5, an air supply coupler 83 for connection with an air supply duct 82 is threaded on the air inlet 6 of the oil coated water droplet generator/mixer 1, and the air supply duct 82 connected to the air supply coupler 83 is connected to a flow control valve 81 to adjust the flow of air. The flow control valve 81 is connected with a compressor 80 to supply air by way of the air supply duct 82.

Also, an oil supply coupler 88 for connection with an oil supply duct 87 is threaded on the oil suction port 16 of the oil coated water droplet generator/mixer 1, and the oil supply duct 87 is connected with an oil measuring valve 86 to measure the quantity of feed oil. The oil measuring valve 86 is connected with an oil pump 85 to supply oil by way of the oil supply duct 87, and the oil pump 85 is connected with an oil tank 84 for storing oil.

Furthermore, a water supply coupler 93 for connection with a water supply duct 92 is threaded on the water suction port 18 of the oil coated water droplet generator/mixer 1, and the water supply duct 92 connected with the water supply coupler 93 is connected with a water measuring valve 91 to measure the quantity of feed water. The water measuring valve 91 is connected with a water pump 90 to supply water by way of the water supply duct 92, and the water pump 90 is connected to a water tank 89 for storing water by the water supply duct 92.

Now, referring to FIGS. 4 and 5, the process wherein oil coated water droplets are generated in the oil coated water droplet generator/mixer 1 using air, oil, and water fed into the oil coated water droplet generator/mixer 1 will be described.

At first, compressed air from the compressor 80 is fed into the oil spray nozzle 9 through the air inlet 6. Also oil from the oil tank 84 flows into the oil spray nozzle 9 through the first oil inlet 10 by way of the oil suction port 16 and the oil suction passage 17. The oil flown into the oil spray nozzle 9 is atomized by pressure of the compressed air in the oil spray nozzle 9, sprayed into the oil atomizing chamber 8, and then fed into the water spray nozzle 12 together with the compressed air. In this case, a portion of oil escaped from being atomized flows along the inner circumferential surface of the oil atomizing chamber 8 in a liquid state into the first bypass passages 20 and then into the first oil inlet grooves 40 and the second oil inlet grooves 41 by way of the bypass passage connecting groove 38 and the second bypass passages 39.

The oil flown into the first oil inlet grooves 40 is sprayed into the second water droplet generation chamber 61 from the second oil inlets 62 arranged in the secondary oil nozzle mount 37. Also the oil flown into the second oil inlet grooves 41 is sprayed into the second water droplet generation chamber 61 from the third oil inlets 63 arranged in the secondary oil nozzle mount 37.

In this case, as the diameter of the second oil inlets 62 is twice as large as that of the third oil inlets 63 and the number of the third oil inlets 63 is a half of that of second oil inlets 62 disposed at a plurality of positions (eight positions in the illustrated embodiment), the flow of oil through the third oil inlets 63 tends to be restricted than through the second oil inlets 62 due to a pressure applied on the third oil inlets 63 higher than that applied on the second oil inlets 62. In other words, it is constructed such that the oil flow through the second oil inlets 62 will become larger than that of through the third oil inlets 63. As such, the oil in the second bypass passages 39 tends to be sprayed into the second water droplet generation chamber 61 through the second oil inlets 62 first, and then into the second water droplet generation chamber 61 through the third oil inlets 63.

On the other hand, water from the water tank 89 flows through the water suction port 18, the water suction passage 19, and the water inlet 13 and then into the water spray nozzle 12. The water flown into the water spray nozzle 12 is dropped by the compressed air fed into the water spray nozzle 12 from the oil atomizing chamber 8 for generation of water droplets. At the same time, the atomized oil adheres to all surfaces of the water droplets and thus oil coated water droplets are generated in the first water droplet generation chamber 36. In this case, oil films do not necessarily adhere to every water droplet and some are present free from oil films.

When sprayed from the first water droplet generation chamber 36 into the second water droplet generation chamber 61, such water droplets free from oil films may be covered throughout their surfaces with oil films generated from the oil flown in through the second oil inlets 62 to become oil coated water droplets. At this stage, most water droplets are coated with oil films and water droplets free from oil films if any will be covered with oil films generated from the oil flown in through the third oil inlets 63 to become oil coated water droplets. As a result, all of the water droplets generated by the water spray nozzle 12 become oil coated water droplets. The oil coated water droplets thus generated pass through the oil coated water droplet discharge port 70 and are discharged out of the oil coated water droplet generator/mixer 1. Here, most of the oil coated water droplets generated by the oil coated water droplet generator/mixer 1 in the present embodiment have the particle size of from 100 μm to 200 μm.

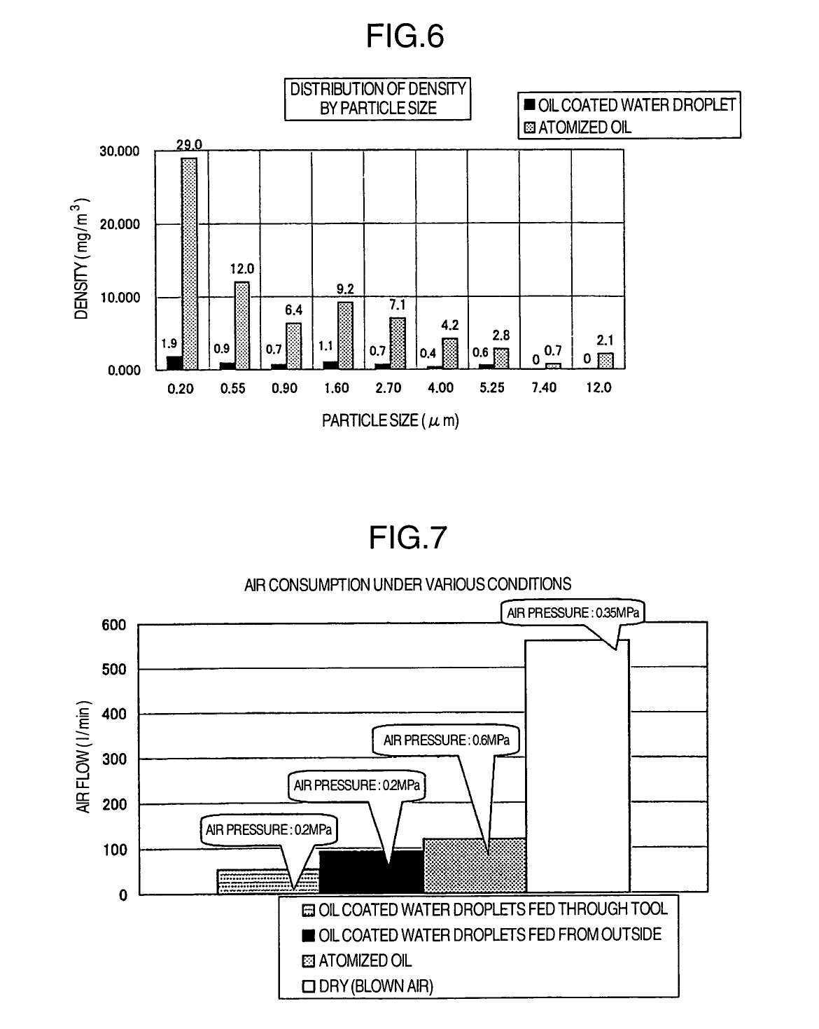

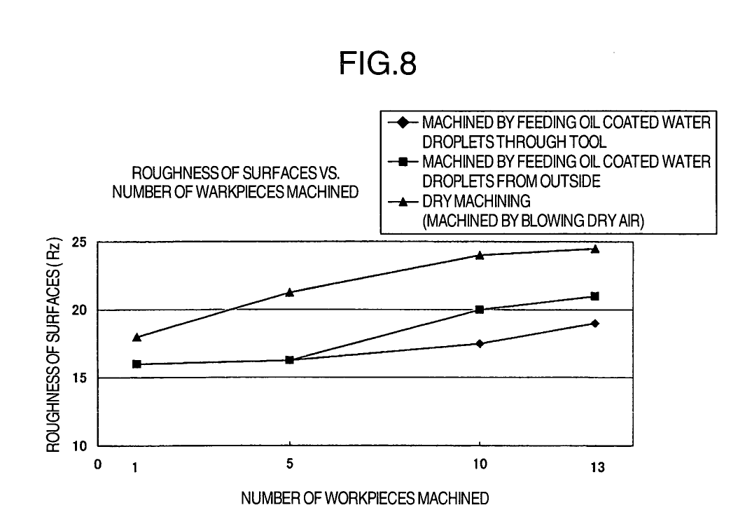

So far the outline of the construction of the tool mount of a machine tool apparatus of the embodiment has been described, and now test results obtained by comparing the coolant supply mechanism of the embodiment and that of the prior art will be described with reference to FIGS. 6 through 8. FIG. 6 is a graph showing a distribution of density by particle size in comparison of the cases; the embodiment of the present invention and spraying of atomized oil in the prior art. FIG. 7 is a graph showing amounts of air consumed in comparison of the present embodiment with respect to spraying of atomized oil and blowing of dry air with the conventional case. FIG. 8 is a graph showing a relationship between the number of workpieces machined and roughness of the surfaces in comparison of the cases; the embodiment and blowing of dry air.

FIG. 6 shows the relationship between average diameters (unit in micrometers) and densities (unit in mg/m³) of particles dispersed in 1 m³ of air when oil coated water droplets were sprayed by the coolant supply mechanism of the present embodiment and conventional atomized oil was sprayed. In case where oil coated water droplets of the present embodiment were sprayed the densities of particles having average diameters in the range of from 0.20 μm to 12.0 μm were less than 2.0 mg/m³, whereas in case where atomized oil was sprayed the densities of particles having average diameters in the same range were from 0.7 m³ to 29.0 mg/m³ and finer particles recorded high densities. These test results indicate that under the conventional method of spraying atomized oil a large amount of particles can be dispersed in the air deteriorating workshop environment, however, in case of spraying oil coated water droplets the amount of particles dispersed in the air can be restrained and favorable workshop environment is maintained. Here, the distribution of densities by particle size as illustrated in FIG. 6 was measured using a piezo-type mass flow meter to which the principle of the Brownian motion (made by Andersen Electronics, Inc.) is applied.

FIG. 7 shows the comparison of the flows of coolant per minute (unit in 1/min.) or air consumption in cases where oil coated water droplets of the present embodiment were supplied from the structural body as shown in FIGS. 1 through 3 (denoted as “oil coated water droplets fed through tool”), oil coated water droplets were sprayed directly from the oil coated water droplet generator/mixer 1 toward the work point (denoted as “oil coated water droplets fed from outside”), atomized oil was sprayed directly toward the work point (denoted as “atomized oil”), and air was blown directly toward the work point (denoted as “dry (blown air)”). When only air was blown toward the work point the air pressure was 0.35 MPa and the air flow was approximately 550 1/min. The air pressure and the air flow to obtain substantially the same cooling effect as above were 0.60 MPa and approximately 110 1/min., respectively, in the case where atomized oil was sprayed toward the work point. When oil coated water droplets were sprayed directly from the oil coated water droplet generator/mixer 1, the air pressure and the air flow were 0.20 MPa and approximately 95 1/min., respectively. When oil coated water droplets were sprayed directly through a tool or a tool mount, the air pressure and the air flow were 0.20 MPa and approximately 60 1/min., respectively. These test results indicate that the case where oil coated water droplets were sprayed through the tool or the tool mount toward the work point the air consumption was the least providing satisfactory cooling effect and rendering economical operations with reduced running costs, and at the same time, demonstrated to be more economical than the case where oil coated water droplets were sprayed directly, not through the tool or the tool mount.

Furthermore, illustrated in FIG. 8 is a relationship between the number of workpieces machined and roughness of the surfaces of the workpieces (unit in Rz) for each of the cases in which oil coated water droplets of the present embodiment were supplied from the structural body as shown in FIGS. 1 through 3 (denoted as “machined by feeding oil coated water droplets through tool”), oil coated water droplets were sprayed directly from the oil coated water droplet generator/mixer 1 toward the work point (denoted as “machined by feeding oil coated water droplets from outside”), and air was blown directly toward the work point (denoted as “dry machining (machined by blowing dry air)”). In all cases roughness of the surfaces increased in accordance with the increase in the number of workpieces machined, however, the two cases wherein oil coated water droplets were sprayed recorded smaller rates of surface deterioration compared with the conventional air blowing. Moreover, in comparison of the two cases wherein oil coated water droplets were sprayed, the case of “machined by feeding oil coated water droplets through tool” recorded smaller rates of increase in the surface roughness than the case of “machined by feeding oil coated water droplets from outside.” As spraying of oil coated water droplets through a tool or a tool mount toward the work point in accordance with the embodiment provides satisfactory lubrication effects, the increase in the surface roughness could be effectively restrained despite of the increase in the number of workpieces machined.

As mentioned above, the machine tool apparatus in accordance with the embodiment of the present invention is provided with the coolant supply passages 108, 110 to feed a coolant to the tools 103 or the tool mounts 101, 102 for mounting the tools 103. To the beginning end of the coolant supply passages 108, 110, the oil coated water droplet generator/mixer 1 is connected thereto, the generation/mixer 1 comprising the oil atomizing chamber 8 to atomize oil introduced from the outside by an air stream, the water droplet generation chambers 36, 61 to generate oil coated water droplets having oil films on the surfaces of the water droplets generated by dropping water introduced from the outside utilizing the air stream containing the atomized oil generated in the oil atomizing chamber 8, and the top nozzle to discharge the oil coated water droplets generated in the water droplet generation chambers 36, 61. To the termination end of the coolant supply passages 108, 110, the spray port 104 having a smaller inner diameter than that of the coolant supply passages 108, 110 is connected such that the oil coated water droplets generated in an atomized state by the oil coated water droplet generator/mixer 1 flow in a liquid state through a coolant supply passages 108, 110 while having a droplet shape on a surface of which in the greater part of oil coated water droplets an oil film is formed and are sprayed again in an atomized state from the spray ports 104 . As a result, excessive dispersion of the coolant in the air is restrained in comparison with the case where only oil is sprayed and satisfactory lubricating and cooling effects are ensured with the minimal quantity of the coolant as the oil coated water droplets adhere to the work surface, and at the same time, excellent workshop environment is provided.

In the embodiment as described above, a turret lathe has been illustrated as an example of machine tools, however, the coolant supply structure in accordance with this invention can be applied to any kinds of machine tools using a coolant including drilling machines, numerical control lathes and the like. Also in the embodiment as described above, the oil coated water droplet generator/mixer 1 is connected with the supply pipe 108 provided in the inside of the turret support 100 by way of the flexible pipe 110, however, the oil coated water droplet generator/mixer 1 may be retained inside the turret support 100 for direct connection to the supply pipe 108. Furthermore, the length of the flexible pipe 110 in accordance with the present embodiment may be approximately 2 m or less to secure sufficient effects as demonstrated in the experiments.

As will be apparent from the foregoing description, the present invention pertaining to claim 1 has advantages that the oil coated water droplets generated in an atmized state by the oil coated water droplet generator/mixer flow in a liquid state through a coolant supply passages while having a droplet shape on a surface of which in the greater part of oil coated water droplets an oil film is formed and are sprayed again in an atomized state of from the spray ports. As a result, excessive dispersion of the coolant in the air is restrained in comparison with the case where only oil is sprayed, and satisfactory lubricating and cooling effects are ensured with the minimal quantity of the coolant since the oil coated water droplets adhere to the work surface, and at the same time, excellent workshop environment is provided.

What is claimed is:

1. A machine tool apparatus provided with coolant supply passages for supplying a coolant in tools or tool mounts for mounting the tools, the apparatus comprising:
an oil coated water droplet generator/mixer being connected to the beginning end of the coolant supply passages, the oil coated water droplet generator/mixer including an oil atomizing chamber for atomizing oil introduced from the outside by an air stream, water droplet generation chambers for generating oil coated water droplets having oil films on the surfaces of the water droplets generated by dropping water introduced from the outside utilizing the air stream containing the atomized oil generated in the oil atomizing chamber, and a top nozzle for discharging the oil coated water droplets generated in the water droplet generation chambers is connected, wherein
a spray port having a smaller inner diameter than the inner diameter of the coolant supply passages is connected to the termination end of said coolant supply passages.
